(19) United States
(12) Patent Application Publication
(10) Pub. No.: US 2008/0318642 A1
(43) Pub. Date: Dec. 25, 2008

(54) COMMUNICATION APPARATUS AND COMMUNICATION METHOD

(75) Inventor: Hironori Tanaka, Fukuoka (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., Osaka (JP)

(21) Appl. No.: 12/135,157

(22) Filed: Jun. 7, 2008

(30) Foreign Application Priority Data
Jun. 8, 2007 (JP) 2007-152315

(51) Int. Cl. H04B 1/38; H04M 1/00

(52) U.S. Cl. 455/572; 455/550.1

(57) ABSTRACT

A communication apparatus includes: a battery; a battery level detecting unit which detects a remaining battery level of the battery; a transmitting unit which transmits data; a wait time setting unit which determines an upper limit value from a minimum upper limit value to a maximum upper limit value for a random number generation range, generates a random number up to the upper limit value, and sets a wait time for transmitting the data on the basis of the random number; and a control unit which sets the minimum and maximum upper limit value for the random number generation range on the wait time setting unit. The control unit sets at least one of the minimum and maximum upper limit value in a different manner from a normal control time in case that the control unit receives data indicating that the remaining battery level is detected to be low.

### BACKGROUND

1. Technical Field

The invention relates to a communication apparatus including a management terminal which is an example of the communication apparatus and a communication method which includes plural communication apparatuses, the communication apparatus and method are used in wireless communication such as a wireless LAN.

2. Background Art

Recently, a wireless communication network has been established, and connection of portable wireless communication terminals to the network has generally been made. Since it is difficult to constantly supply the portable wireless communication terminals with power from the wall socket, a battery is used as a driving source. However, when a remaining battery level becomes low, it is also difficult to charge the battery in many cases. Accordingly, suppressing unnecessary power consumption has been carried out in such a way that information on the remaining battery level is notified to set a transmission speed, a transmission mode, and a power controlling method on the basis of the remaining battery level (See, for example, JP-B-3410892).

However, in a known communication system for reducing power consumption, reducing the power consumption is carried out after a communication terminal obtains an access right to a communication channel. In an access mode such as a CSMA/CA (Carrier Sense Multiple Access with Collision Avoidance) in which it is necessary to delay data transmission when a communication channel is detected not to be empty, a power saving terminal for repeating power-on and power-off operations to reduce the power consumption can coexist with plural communication terminals. In this case, when the power saving terminal turns on power to transmit a frame, but fails to obtain a frame transmission right, the power saving terminal has to continuously turn on power until another communication terminal completes the frame transmission. Therefore, there occurs a problem in that the power consumption cannot be suppressed.

### SUMMARY

The invention is devised in view of this circumstance, and an object of the invention is to provide a communication apparatus and a communication method capable of more reducing the power consumption more than that at normal time and being good at reducing power consumption.

In order to solve the above problems, there is provided a communication apparatus, comprising: a battery; a battery level detecting unit which detects a remaining battery level of the battery; a transmitting unit which transmits data; a wait time setting unit which determines an upper limit value from a minimum upper limit value to a maximum upper limit value for a random number generation range when the transmitting unit transmits the data, generates a random number up to the upper limit value, and sets a wait time for transmitting the data on the basis of the random number; and a control unit which sets the minimum upper limit value and the maximum upper limit value for the random number generation range on the wait time setting unit, wherein the control unit sets at least one of the minimum upper limit value and the maximum upper limit value in a different manner from a normal control time in case that the control unit receives data indicating that the remaining battery level is detected to be low from the battery level detecting unit.

According to the invention, frame transmission is possible in time shorter than that in a normal process when a communication terminal having its low remaining battery level transmits a frame. Accordingly, since it is easier for the communication terminal to win contention for obtaining a frame transmission right over another communication terminal, it is possible to reduce a probability that the communication terminal turns on power while another communication terminal is transmitting the frame transmission. As a result, it is possible to provide the communication terminal capable of reducing the power consumption when the remaining battery level becomes lower than that at a normal time, that is, when power consumption has to be reduced more than that at the normal time.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a perspective view illustrating the appearance of a communication terminal;

FIG. 2 is a block diagram illustrating an example of hardware of the communication terminal;

FIG. 3 is a perspective view illustrating the appearance of a management terminal (front side);

FIG. 4 is a perspective view illustrating the appearance of the management terminal (rear side);

FIG. 5 is a block diagram illustrating an example of hardware of the management terminal;

FIG. 6 is a block diagram illustrating functions of the communication terminal;

FIG. 7 is a block diagram illustrating functions of the management terminal;

FIG. 8 is a time chart for operations in a communication system according to a first embodiment;

FIG. 9 is a time chart for operations in a communication system according to a second embodiment;

FIG. 10 is a time chart for the operations in the communication system according to the second embodiment;

FIG. 11 is a time chart for operations in a communication system according to a third embodiment; and

FIG. 12 is a time chart for operations in a communication system according to a fourth embodiment.

### DETAILED DESCRIPTION

According to an aspect of the invention, a communication apparatus, which is a power saving communication terminal for repeating power-on and power-off operations to transmit a frame, includes a battery level detecting unit which detects its remaining battery level; a receiving unit which receives a frame; a transmitting unit which transmits a frame; a transmission frame generating unit which generates a transmission frame to be transmitted by the transmitting unit; a frame content reading unit which reads the contents stored in the frame received by the receiving unit; a retransmission control unit which determines whether to retransmit the transmitted transmission frame when the frame content reading unit does not detect a reception response frame with respect to the transmitted transmission frame after the transmitting unit transmits the transmission frame; a transmission wait time setting unit which determines an upper limit value between a minimum upper limit value and a maximum upper limit value of a random number generation range at the time of transmitting the transmission frame, generates random numbers distributed uniformly from 0 to the upper limit value, and sets transmission wait time for transmitting the transmission frame on the basis of the random numbers, and which generates the minimum upper limit value as the upper limit value at the time of initially transmitting the transmission frame and sequentially increases the upper limit value up to the maximum upper limit value to generate the random numbers when the retransmission control unit determines retransmission of the transmission frame; and a control unit which allows the transmission wait time setting unit to set transmission and reception of a frame and the minimum upper limit value and the maximum upper limit value of the random number generation range. In the communication terminal, the control unit allows the transmission wait time setting unit to set a minimum upper limit value smaller than the minimum upper limit value at a normal time, when the battery level detecting unit notifies that its remaining battery level has been low. With such a configuration, the power saving communication terminal having its low remaining battery level can transmit a frame at time shorter than that at the normal time when it transmits the frame. Accordingly, since it is easy to win contention for obtaining a frame transmission right over another communication terminal, it is possible to decrease a probability that power-on state continues during the time when another communication terminal transmits a frame. As a result, it is possible to obtain an advantage of reducing power consumption when the remaining battery level is low, that is, when power consumption has to be reduced more than that at the normal time.

According to another aspect of the invention, a communication apparatus, which is a power saving communication terminal for repeating power-on and power-off operations to transmit a frame, includes a battery level detecting unit which detects its remaining battery level; a receiving unit which receives a frame; a transmitting unit which transmits a frame; a transmission frame generating unit which generates a transmission frame to be transmitted by the transmitting unit; a frame content reading unit which reads the contents stored in the frame received by the receiving unit; a retransmission control unit which determines whether to retransmit the transmitted transmission frame when the frame content reading unit does not detect a reception response frame with respect to the transmitted transmission frame after the transmitting unit transmits the transmission frame; a transmission wait time setting unit which determines an upper limit value between a minimum upper limit value and a maximum upper limit value of a random number generation range at the time of transmitting the transmission frame, generates random numbers distributed uniformly from 0 to the upper limit value, and sets transmission wait time for transmitting the transmission frame on the basis of the random numbers, and which generates the minimum upper limit value as the upper limit value at the time of initially transmitting the transmission frame and sequentially increases the upper limit value up to the maximum upper limit value to generate the random numbers when the retransmission control unit determines retransmission of the transmission frame; and a control unit which allows the transmission wait time setting unit to set transmission and reception of a frame and the minimum upper limit value and the maximum upper limit value of the random number generation range. In the communication terminal, the control unit allows the transmission wait time setting unit to set the maximum upper limit value as the same value as the minimum upper limit value, when the battery level detecting unit notifies that its remaining battery level has been low. With such a configuration, the power saving communication terminal having its low remaining battery level can retransmit the frame at time shorter than that at the normal time when transmitting the frame. Accordingly, since it is easy to win contention for obtaining a frame transmission right over another communication terminal, it is possible to decrease a probability that power-on state continues during the time when another communication terminal transmits a frame. As a result, it is possible to obtain an advantage of reducing power consumption when the remaining battery level is low, that is, when power consumption has to be reduced more than that at the normal time.

According to another aspect of the invention, in the above-mentioned communication apparatus, the control unit allows the transmission frame generating unit to generate its low remaining battery level frame for notifying that the remaining battery level of the communication terminal is low when the battery level detecting unit notifies that the remaining battery level has been low, and allows the transmitting unit to transmit to another communication terminal the frame indicating that the remaining battery level has been low. In this way, it is possible to obtain an advantage of surely notifying another communication terminal that the remaining battery level of the communication terminal has been low.

According to another aspect of the invention, a communication apparatus includes a battery level detecting unit which detects its remaining battery level; a receiving unit which receives a frame; a transmitting unit which transmits a frame; a transmission frame generating unit which generates a transmission frame to be transmitted by the transmitting unit; a frame content reading unit which reads the contents stored in the frame received by the receiving unit; a retransmission control unit which determines whether to retransmit the transmitted transmission frame when the frame content reading unit does not detect a reception response frame with respect to the transmitted transmission frame after the transmitting unit transmits the transmission frame; a transmission wait time setting unit which determines an upper limit value between a minimum upper limit value and a maximum upper limit value of a random number generation range at the time of transmitting the transmission frame, generates random numbers distributed uniformly from 0 to the upper limit value, and sets transmission wait time for transmitting the transmission frame on the basis of the random numbers, and which generates the minimum upper limit value as the upper limit value at the time of initially transmitting the transmission frame and sequentially increases the upper limit value up to the maximum upper limit value to generate the random numbers when the retransmission control unit determines retransmission of the transmission frame; and a control unit which allows the transmission wait time setting unit to set transmission and reception of a frame and the minimum upper limit value and the maximum upper limit value of the random number generation range. In the communication terminal, the control unit allows the transmission wait time setting unit to set a minimum upper limit value smaller than the minimum upper limit value at the normal time, when receiving from another communication terminal that the remaining battery level of another communication terminal has been low. With such a configuration, the communication terminal can retransmit the frame at time shorter than that at the normal time, when it transmits the frame to another communication terminal having the low remaining battery level. Accordingly, since it is easy to win contention for obtaining a frame transmission right over other communication terminals, it is possible to decrease a probability that another communication terminal turns on power to receive a frame while another communication terminals transmits a frame. As a result, it is possible to obtain an advantage of reducing power consumption when the remaining battery level of another communication terminal is low, that is, when power consumption has to be reduced more than that at the normal time.

According to another aspect of the invention, a communication terminal includes a battery level detecting unit which detects its remaining battery level; a receiving unit which receives a frame; a transmitting unit which transmits a frame; a transmission frame generating unit which generates a transmission frame to be transmitted by the transmitting unit; a frame content reading unit which reads the contents stored in the frame received by the receiving unit; a retransmission control unit which determines whether to retransmit the transmitted transmission frame when the frame content reading unit does not detect a reception response frame with respect to the transmitted transmission frame after the transmitting unit transmits the transmission frame; a transmission wait time setting unit which determines an upper limit value between a minimum upper limit value and a maximum upper limit value of a random number generation range at the time of transmitting the transmission frame, generates random numbers distributed uniformly from 0 to the upper limit value, and sets transmission wait time for transmitting the transmission frame on the basis of the random numbers, and which generates the minimum upper limit value as the upper limit value at the time of initially transmitting the transmission frame and sequentially increases the upper limit value up to the maximum upper limit value to generate the random numbers when the retransmission control unit determines retransmission of the transmission frame; and a control unit which allows the transmission wait time setting unit to set transmission and reception of a frame and the minimum upper limit value and the maximum upper limit value of the random number generation range. In the communication terminal, the control unit allows the transmission wait time setting unit to set the maximum upper limit value as the same value as the minimum upper limit value, when it receives from another communication terminal that the remaining battery level of another communication terminal has been low. With such a configuration, the communication terminal can retransmit the frame at time shorter than that at the normal time, when it transmits the frame to another communication terminal having the low remaining battery level. Accordingly, since it is easy to win contention for obtaining a frame transmission right over other communication terminals, it is possible to decrease a probability that another communication terminal turns on power to receive a frame while another communication terminals transmits a frame. As a result, it is possible to obtain an advantage of reducing power consumption when the remaining battery level of another communication terminal is low, that is, when power consumption has to be reduced more than that at the normal time.

According to another aspect of the invention, a communication apparatus, which is a power saving communication terminal for repeating power-on and power-off operations to transmit a frame, includes a battery level detecting unit which detects its remaining battery level; a receiving unit which receives a frame; a transmitting unit which transmits a frame; a transmission frame generating unit which generates a transmission frame to be transmitted by the transmitting unit; a power on/off unit which switches power-on and power-off of the transmitting unit; a transmission frame content storing unit which stores the transmission frame; and a control unit which control transmission and reception of the frame and allows the power-on/off unit to turn on and off the power of the transmission unit. In the communication terminal, the control unit allows the power-on/off unit to turn on the power of the transmission unit under the condition that plural transmission frames are stored in the transmission frame content storing unit, and allows the transmitting unit to transmit the plural transmission frames. With such a configuration, the plural transmission frames are transmitted at one time when the power saving communication terminal having the low remaining battery level transmits the frames, thereby reducing the setup time necessary to turn on power in order to transmit the frames. As a result, since the power-on time of the communication terminal can be reduced, it is possible to obtain an advantage of reducing power consumption when the remaining battery level is low, that is, when power consumption has to be reduced more than that at the normal time.

According to another aspect of the invention, a communication apparatus, which is managed by a management terminal and is a power saving communication terminal for repeating power-on and power-off operations to transmit a frame, includes a battery level detecting unit which detects its remaining battery level; a receiving unit which receives a frame; a transmitting unit which transmits a frame; a transmission frame generating unit which generates a transmission frame to be transmitted by the transmitting unit; a frame content reading unit which reads the contents of the frame transmitted from the transmitting unit; a power on/off unit which switches power-on and power-off of the receiving unit, the transmitting unit, the transmission frame generation unit, and the frame content reading unit on the basis of a command of the power-on and power-off; a transmission frame content storing unit which stores the transmission frame; and a control unit which control transmission and reception of the frame and allows the power-on/off unit to turn on and off the power of the transmission unit. In the communication terminal, the control unit does not transmit the frame at timing of storing the transmission frame to the transmission frame content storing unit, when the battery level detecting unit notifies that the remaining battery level has been low. The control unit allows the power-on/off unit to turn on power at timing of receiving a reference frame from the management terminal. Additionally, the control unit allows the transmitting unit to transmit the transmission frame stored in the transmission frame content storing unit, when the frame content reading unit notifies the reception of the reference frame. In this way, the power saving communication terminal having the low remaining battery level transmits the frame when it turns on power in order to receive the reference frame of the management terminal. Accordingly, setup time necessary for the communication terminal to turn on power just to transmit the frame is not required. As a result, since the power-on time of the communication terminal can be reduced, it is possible to obtain an advantage of reducing power consumption when the remaining battery level is low, that is, when power consumption has to be reduced more than that at the normal time.

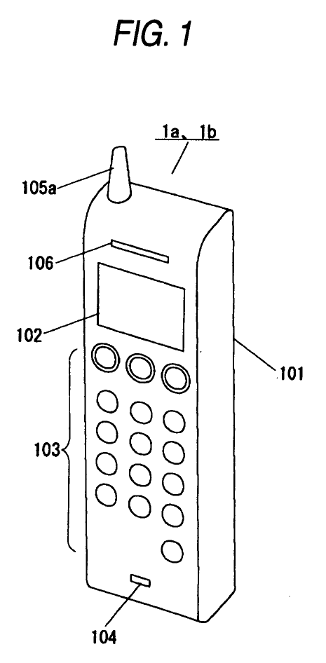

Hereinafter, exemplary embodiments of the invention will be described with reference to FIGS. 1 to 12. The mutually related parts and elements among the embodiments are interoperable to each other.

### FIRST EMBODIMENT

A first embodiment of the invention will be described with reference to FIGS. 1 to 8. FIG. 1 is a perspective view illustrating the appearance of a communication terminal according to the first embodiment. In FIG. 1, Reference Numerals 1a and 1b denote communication terminals and Reference Numeral 101 denotes a housing of the respective communication terminals 1a and 1b. Reference Numeral 102 denotes an LCD (Liquid Crystal Display) which is formed on the outer surface of the housing 101 and displays a telephone number, etc. Reference Numeral 103 denotes a key matrix which is formed on the outer surface of the housing 101 and is constituted by buttons for designating telephone numbers, etc. Reference Numeral 104 denotes a microphone which is formed on the outer surface of the housing 101. Reference Numeral 105a denotes an antenna which protrudes from the outer surface of the housing 101 and which transmits and receives radio waves. Reference Numeral 106 denotes a speaker which is formed on the outer surface of the housing 101 and outputs voice from a communication opponent.

According to this embodiment, the communication terminals 1a and 1b each having the above-described configuration are portable telephone terminals. As an example of the communication terminal, the telephone terminal is shown in FIG. 1, but the communication terminal according to the invention is particularly not limited to the telephone terminal. The communication terminal according to the invention may be an apparatus (for example, an electronic apparatus such as a personal computer) having a function capable of connecting with another communication terminal including an access point.

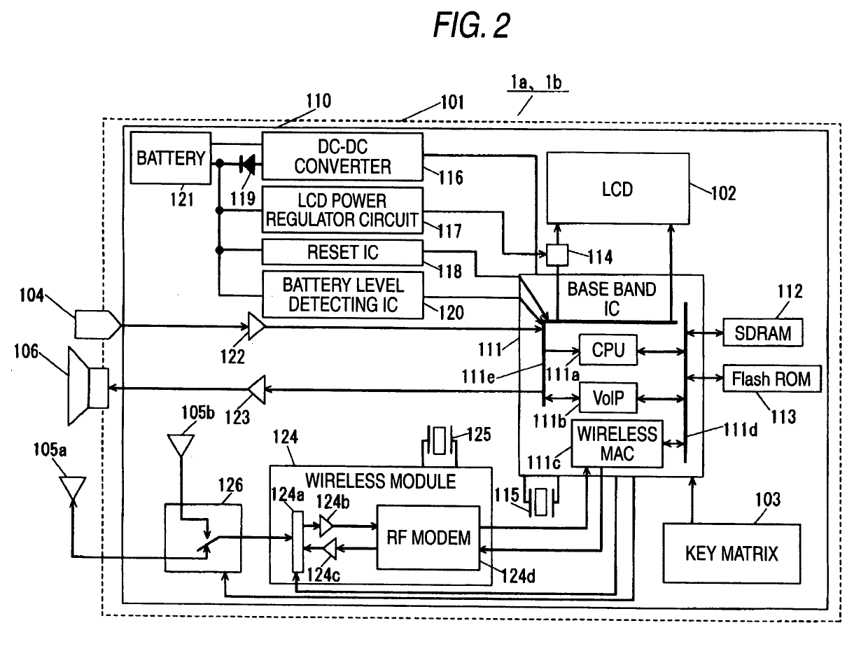

FIG. 2 is a block diagram illustrating an example of hardware of the communication terminal. In FIG. 2, Reference Numeral 110 denotes a circuit module inside the housing 101 indicated by a dashed line. Reference Numeral 111 denotes a base band IC (Integrated Circuit) which is mounted in the circuit module 110. Reference Numeral 124 denotes a wireless module which is mounted in the circuit module 110.

Reference Numeral 111a denotes a CPU (Central Processing Unit) which is provided in the base band IC 111. Reference Numeral 111b denotes a VoIP (Voice over Internet Protocol) block which is provided in the base band IC 111 and performs a voice process. Reference Numeral 111c denotes a wireless MAC block which is provided in the base band IC 111 and controls a MAC (Medium Access Control) layer of a wireless LAN (Local Area Network). Reference Numeral 111d denotes a main bus which is provided in the base band IC 111. Reference Numeral 111e denotes a local bus which is provided in the base band IC 111.

Reference Numeral 112 denotes a SDRAM (Synchronous Dynamic Random Access Memory) which is mounted in the circuit module 110. Reference Numeral 113 denotes a flash ROM (flash Read-Only Memory) which is mounted in the circuit module 110.

The CPU 111a, the VoIP block 111b, and the wireless MAC block 111c in the base band IC 111 are connected to the SDRAM 112 and the flash ROM 113 through the main bus 111d.

In FIG. 2, Reference Numeral 102 denotes an LCD which is mounted in the circuit module 110, Reference Numeral 114 denotes an LCD power control IC which is mounted in the circuit module 110 and controls power of the LCD, and Reference Numeral 116 denotes a DC-DC (Direct Current to Direct Current) converter which is mounted in the circuit module 110 and converts voltage into necessary DC (Direct Current) voltage. Reference Numeral 118 denotes a reset IC which is mounted in the circuit module 110 and notifies a reset signal. Reference Numeral 120 denotes a battery level detecting IC which is mounted in the circuit module 110 and connected to a battery 121 and which measures the voltage of the battery 121 to notify that the remaining battery level is low.

The CPU 111a is connected to the LCD 102, the LCD power control IC 114, the DC-DC converter 116, the reset IC 118, and the battery level detecting IC 120 through the local bus 111e.

Reference Numeral 117 denotes an LCD power boosting circuit which is connected to the battery 121 and boosts the voltage necessary for the LCD 102. As well as the battery level detecting IC 120, the LCD power boosting circuit 117 and the reset IC 118 are connected to the battery 121. Moreover, the DC-DC converter 116 is connected thereto through a diode 119.

Reference Numeral 122 denotes an amplifier which amplifies a signal from the microphone 104. Reference Numeral 123 denotes an amplifier which amplifies a signal from the speaker 106. The amplifiers 122 and 123 are connected to the microphone 104 and the speaker 106, respectively. In addition, the CPU 111a and the VoIP block 111b are connected to the amplifiers 122 and 123 through the local bus 111e.

In FIG. 2, Reference Numeral 115 denotes an oscillator which is mounted in the circuit module 110 and supplies clock information to the base band IC 111. Reference Numeral 126 denotes an antenna switching SW (SWitch) which is mounted in the circuit module 110 and switches an antenna to be used from the base band IC 111. The base band IC 111 is connected to the key matrix 103, the oscillator 115, a wireless module 124, and the antenna switching SW 126.

Reference Numeral 124a denotes a transmission and reception switching SW which is included in the wireless module 124. Reference Numeral 124b denotes an LNA (Low Noise Amplifier) which is included in the wireless module 124 and amplifies a received signal. Reference Numeral 124c denotes a PA (Power Amplifier) which is included in the wireless module 124 and amplifies the received signal. Reference Numeral 124d denotes a RF (Radio Frequency) modem which is included in the wireless module 124 and which modulates and demodulates a wireless signal.

Reference Numeral 125 denotes an oscillator which supplies clock information to the wireless module 124, and the wireless module 124 is connected to the oscillator 125 and the antenna switching SW 126. The antenna switching SW 126 is connected to the external antenna 105a shown in FIG. 1 and an internal antenna 105b.

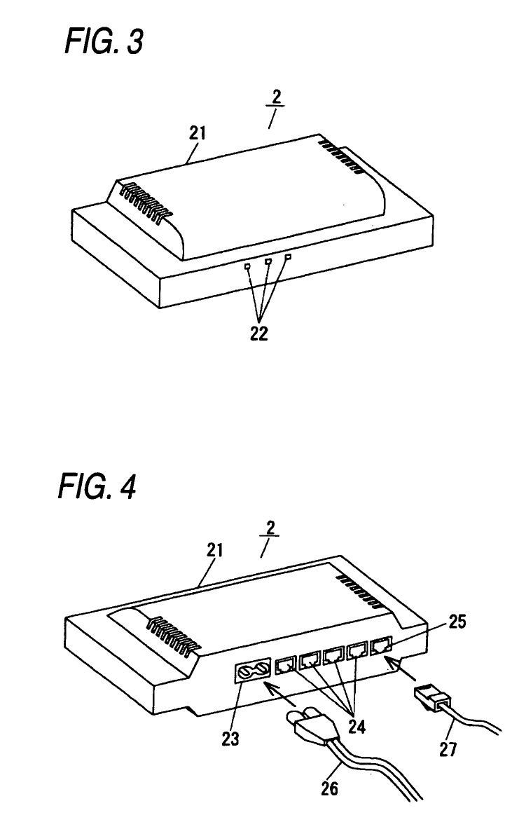

FIG. 3 is a perspective view illustrating the front side of a management terminal, which is an example of the communication terminal. FIG. 4 is a perspective view illustrating the rear side of the management terminal. In this embodiment, a management terminal 2 shown in FIG. 3 is a router.

In FIG. 3, Reference Numeral 21 denotes a frame of the management terminal 2, and Reference Numeral 22 denotes a display unit such as LED (Light Emitting Diode) formed in the front surface of the case 21.

In FIG. 4, Reference Numeral 23 denotes a DC power connector which is formed on the rear surface of the frame 21, Reference Numeral 24 denotes an LAN modular jack such as RJ 45 which is formed on the rear surface of the frame 21, and Reference Numeral 25 denotes a WAN (Wide Area Network) modular jack which is formed on the rear surface of the frame 21. In addition, Reference Numeral 26 denotes a power line such as a parallel cable which is connected to a DC power connector 23 and Reference Numeral 27 denotes an LAN cable which is connected to the LAN modular jack 24 and the WAN modular jack 25.

As the example of the management terminal, the router is shown in FIGS. 3 and 4, but the management terminal according to the invention is particularly not limited to the router. The management terminal according to the invention may be an apparatus (for example, an electronic apparatus such as a television) having a function of an access point.

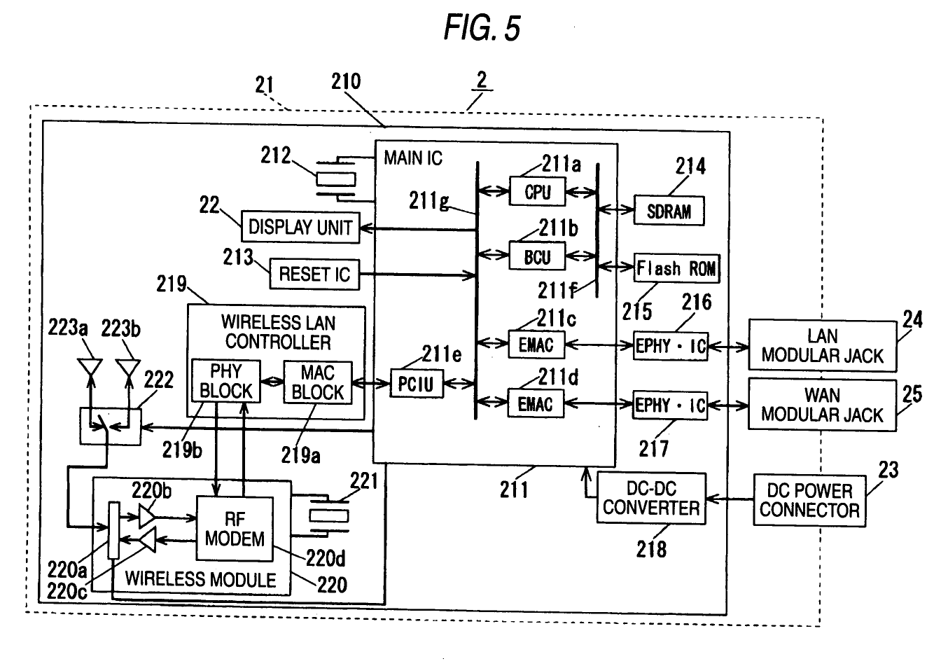

FIG. 5 is a block diagram illustrating an example of hardware of the management terminal 2. In FIG. 5, Reference Numeral 210 denotes a circuit module inside the case 21 indicated by a dashed line. Reference Numeral 211 denotes a main IC which is mounted in the circuit module 210, Reference Numeral 219 denotes a wireless LAN controller which is mounted in the circuit module 210, and Reference Numeral 220 denotes a wireless module which is mounted in the circuit module 210.

Reference Numeral 211a denotes a CPU which is provided in the main IC 211. Reference Numeral 211f denotes a main bus which is provided in the main IC 211. Reference Numeral 211g denotes a local bus which is provided in the main IC 211. Reference Numeral 211b denotes a BCU (Bus Control Unit) which is provided in the main IC 211 and controls the flow of data in the bus. Reference Numerals 211c and 211d each denote a MAC block (EMAC) which controls the MAC layer of an Ethernet (registered trademark). Reference Numeral 211e denotes a PCIU (Peripheral Component Interconnect Unit) which controls the bus of a PCI.

Reference Numeral 214 denotes a SDRAM which is mounted in the circuit module 210. Reference Numeral 215 denotes a flash ROM which is mounted in the circuit module 210. Reference Numeral 212 denotes an oscillator which supplies clock information to the main IC 211. Reference Numeral 22 denotes a display unit such as LED. Reference Numeral 213 denotes a reset IC which outputs a reset signal to the main IC 211.

The CPU 211a and the BCU 211b in the main IC 211 are connected to the SDRAM 214 and the flash ROM 215 through the main bus 211f. In addition, the CPU 211a and the BCU 211b are connected to the oscillator 212, the display unit 22, and the reset IC 213 through the local bus 211g.

Reference Numerals 216 and 217 each denote an EPHY (Ethernet (registered trademark) PHYsical Layer) IC which controls the physical layer of the Ethernet (registered trademark). The EMAC blocks 211c and 211d in the main IC 211 are connected to the EPHY (Ethernet (registered trademark) PHYsical layer) ICs 216 and 217, respectively. The EPHY ICs 216 and 217 are connected to the WAN modular jack 24 and the LAN modular jack 25, respectively.

Reference Numeral 218 denotes a DC-DC converter which is mounted in the circuit module 210 and converts the DC voltage supplied from the DC power connector 23 into the DC voltage necessary for the main IC 211. The main IC 211 is connected to the DC power connector 23 through the DC-DC converter 218.

Reference Numeral 219a denotes a MAC block which is included in a wireless LAN controller 219 and controls the MAC layer, and Reference Numeral 219b denotes a PHY block which is included in the wireless LAN controller 219 and controls the physical layer. The PCIU 211e in the main IC 211 is connected to the PHY block 219b through the MAC block 219a.

In the wireless module 220, a transmission state or a reception state is set by the main IC 211. Reference Numeral 220a denotes a transmission and reception switching SW which is included in the wireless module 220, Reference Numeral 220b denotes an LNA which is included in the wireless module 220 and amplifies a received signal, and Reference Numeral 220c denotes a PA which is included in the wireless module 220 and amplifies a transmitted signal. The transmission and reception switching SW 220a is connected to antennas 223a and 223b through an antenna switching SW 222 which switches an antenna used in the main IC 211. In addition, Reference Numeral 220d denotes an RF modem which modulates and demodulates a wireless signal and is connected to the PHY block 219b in the wireless LAN controller 219. Reference Numeral 221 denotes an oscillator which is connected to the wireless module 220 and supplies clock information to the wireless module 220.

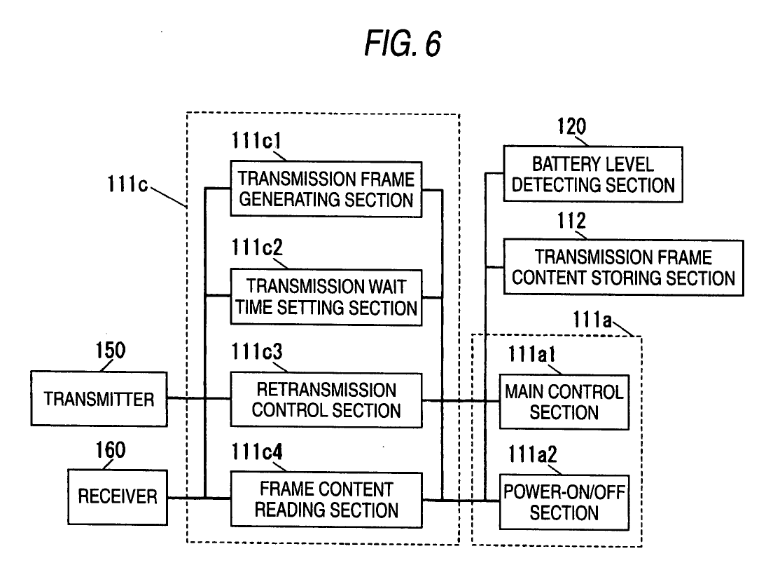

FIG. 6 is a block diagram illustrating functions of the communication terminal. In FIG. 6, Reference Numeral 150 denotes a transmitting unit, Reference Numeral 160 denotes a receiving unit, Reference Numeral 111c1 denotes a transmission frame generating section, Reference Numeral 111c2 denotes a transmission wait time setting section, Reference Numeral 111c3 denotes a retransmission control section, Reference Numeral 111c4 denotes a frame content reading section, Reference Numeral 120 denotes a battery level detecting unit, Reference Numeral 112 denotes a transmission frame content storing unit (SDRAM), Reference Numeral 111a1 denotes a main control section, and Reference Numeral 111a2 denotes a power-on/off section.

In this case, the transmission frame generating section 111c1, the transmission wait time setting section 111c2, the retransmission control section 111c3, and the frame content reading section 111c4 are constituent elements of the wireless MAC block 111c. The main control section 111a1 and the power-on/off section 111a2 are constituent elements of the CPU 111a which is a constituent element of the base band IC 111. The transmitting unit 150 and the receiving unit 160 are constituted by the wireless module 124, the oscillator 125, the antenna switching SW 126, the external antenna 105a, and the internal antenna 105b.

The battery level detecting unit 120 notifies the main control section 111a1 that the remaining battery level has been low when the voltage of the battery becomes lower than predetermined voltage. The battery level detecting unit 120 notifies the main control section 111a1 that the voltage of the battery is not lower than the predetermined voltage when the voltage of the battery is not lower than the predetermined voltage.

The power-on/off section 111a2 turns off the power of the transmitting unit 150, the receiving unit 160 and the wireless MAC block 111c when it is notified so as not to perform power supply from the main control section 111a1. Alternatively, the power-on/off section 111a2 turns on the power of the transmitting unit 150, the receiving unit 160 and the wireless MAC block 111c when it is notified so as to perform the power supply. The retransmission control section 111c3 determines whether to retransmit a frame when the frame content reading section 111c4 does not detect a reception response frame, after a frame generated in the transmission frame generating section 111c1 is transmitted from the transmitting unit 150.

The transmitting unit 150 transmits a frame over the air, and the receiving unit 160 receives a frame from the air. The frame received by the receiving unit 160 is delivered to the frame content reading section 111c4. Then, the frame content reading section 111c4 abandons the frame when the received frame is not normal. In contrast, in case the received frame is normal, the frame content reading section 111c4 notifies the retransmission control section 111c3 when the content of the frame is a reception response, and notifies the main control section 111a1 when the content of the frame is not the reception response.

Next, a case where the battery level detecting unit 120 notifies the main control section 111a1 that the voltage of the battery is not lower than the predetermined voltage, that is, a case where a frame is transmitted at the normal time will be described. The main control section 111a1 sets an offset value, a minimum upper limit value, and a maximum upper-limit on the transmission wait time setting section 111c2 when transmitting a frame. The main control section 111a1 allows the transmission frame generating section 111c1 to generate a frame of which the content stored in the transmission frame content storing unit 112 can be transmitted through a communication channel. The transmission frame generating section 111c1 notifies the transmission wait time setting unit 111c2 that the generated frame is to be transmitted.

The transmission wait time setting section 111c2 determines an upper limit value from the minimum upper limit value to the maximum upper limit value for a random number generation range when a transmission frame is transmitted; generates a random number distributed uniformly from 0 to the upper limit value; and sets transmission wait time used to transmit the transmission frame on the basis of the random number. The random number is generated by setting the minimum upper limit value as the upper limit value when the transmission frame is initially transmitted. In addition, the random number is generated by sequentially increasing the upper limit value up to the maximum upper limit value, when the retransmission control unit 111c3 determines retransmission of the transmission frame.

The transmission wait time setting section 111c2 having such a processing function determines an arbitrary value as basic unit time for the transmission wait from a range of 0 to the minimum upper limit value set in the main control section 111a1, and starts to monitor the output of the receiving unit 160. When confirming that the output from the receiving unit 160 has not been present during a period obtained by multiplying the offset value by the basic unit time (hereinafter, referred to as offset time confirmation), the transmission wait time setting unit 111c2 decreases the basic unit time for transmission wait by one unit (hereinafter, referred to as a transmission wait subtraction process) at every interval of the basic unit time.

If the output from the receiving unit 160 is present before the basic unit time for transmission wait becomes 0, the transmission wait time setting section 111c2 interrupts the transmission wait subtraction process, and resumes the transmission wait subtraction process after it again confirms the offset time. When the basic unit time for transmission wait becomes 0, the transmission wait time setting section 111c2 notifies the transmission frame generating section 111c1 of transmission permission. The transmission frame generating section 111c1 which has received the transmission permission delivers the transmission frame to the transmission unit 150. The transmitting unit 150 transmits the transmission frame over the air.

In a case of a unicast frame which is a frame transmitted to only one transmission destination, the transmission frame generating section 111c1 notifies the retransmission control section 111c3 that the transmission frame is to be transmitted. The retransmission control section 111c3 confirms that the reception of the reception response frame from the transmission destination has been notified from the frame content reading section 111c4 within the basic unit time. When the reception of the reception response frame is not notified, the retransmission control section 111c3 notifies the transmission frame generating section 111c1 that the transmission frame is retransmitted. The transmission frame generating section 111c1 notifies the transmission wait time setting section 111c2 that the transmission frame is first retransmitted.

The transmission wait time setting section 111c2 determines an arbitrary value as basic unit time for transmission wait from a range of 0 to the next large upper limit value of the minimum upper limit value, and performs the processes from the transmitting of the transmission frame to the confirming of the reception of the reception response frame, in the same way as that in the above description. The retransmission control section 111c3 performs the processes from the transmitting of the transmission frame to the confirming of the reception of the reception response frame by the number of retransmission set in the main control section 111a1, in the same way as that in the above description. If the reception of the reception response frame fails even in the processes, the fact that the transmitting of the reception frame has failed is notified to the main control section 111a1.

There is a difference in transmitting a frame when the battery level detecting unit 120 notifies the main control section 111a1 that the battery voltage has been lower than a predetermined voltage, compared to the above-described processes. That is, the main control section 111a1 sets the minimum upper limit value, which is smaller than that when the battery voltage is not lower than the predetermined voltage as the minimum upper limit value at the time of transmitting a frame on the transmission wait time setting section 111c2.

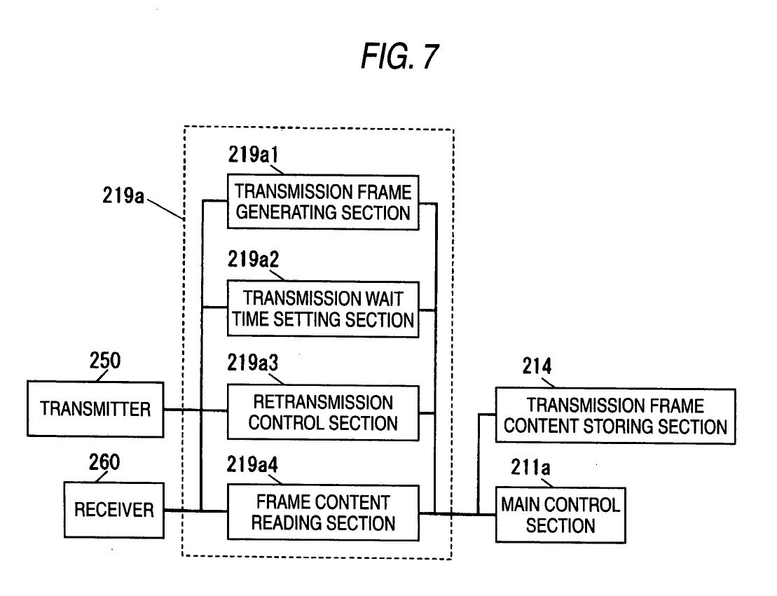

FIG. 7 is a block diagram illustrating functions of the management terminal 2. In FIG. 7, Reference Numeral 250 denotes a transmitting unit, Reference Numeral 260 denotes a receiving unit, Reference Numeral 219a1 denotes a transmission frame generating section, Reference Numeral 219a2 denotes a transmission wait time setting section, Reference Numeral 219a3 denotes a retransmission control section, Reference Numeral 219a4 denotes a frame content reading section, Reference Numeral 214 denotes a transmission frame content storing unit (SDRAM), and Reference Numeral 211a denotes a main control section.

The transmission frame generating section 219a1, the transmission wait time setting section 219a2, the retransmission control section 219a3, and the frame content reading section 219a4 are constituent elements of a MAC block 219a. The transmitting unit 250 and the receiving unit 260 are constituted by the wireless module 220, the oscillator 221, the antenna switching SW 222, the antenna 223a, and the antenna 223b. In FIG. 7, operations of the elements having the equal functions as those in FIG. 6 are the same as those described in FIG. 6.

In a case of transmitting a frame when the fact that the battery voltage of the communication terminal is lower than the predetermined voltage is notified to the management terminal 2, the main control section 211a sets the minimum upper limit value which is smaller than the minimum upper limit value at the time at which the battery voltage is not lower than the predetermined voltage, as a minimum upper limit value at the time of transmitting the frame on the transmission wait time setting section 219a2.

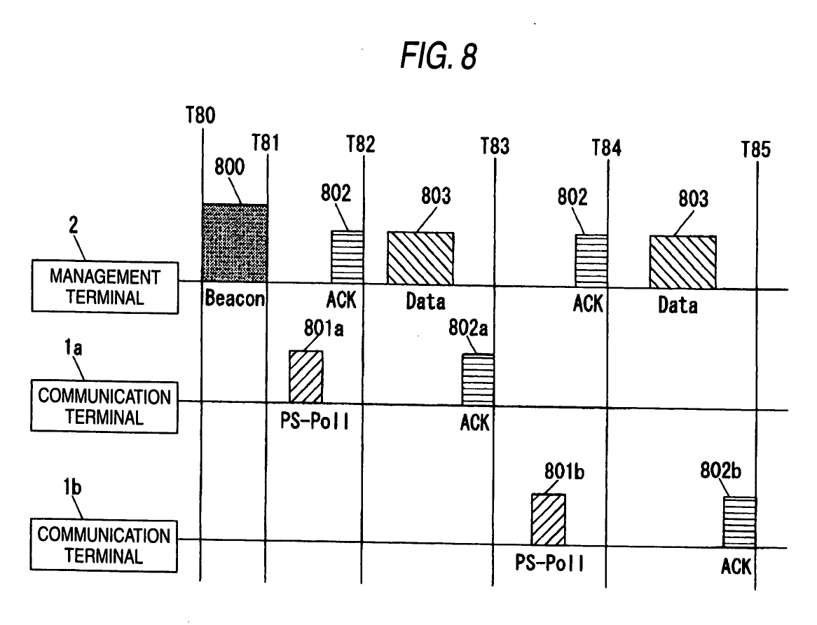

FIG. 8 is a time chart in a communication system according to the first embodiment and shows that the communication terminals 1a and 1b, which are each a power saving communication terminal for repeating power-on and power-off operations, and receive one frame stored in the management terminal 2, respectively. The management terminal 2 and the communication terminal 1a are embodied according to the invention, but the communication terminal 1b is not embodied according to the invention.

Until a time point of time T80, the battery level detecting unit 120 notifies the main control section 111a1 of the communication terminal 1a that the remaining battery level has been low. In addition, the main control section 211a of the management terminal 2 receives from the communication terminal 1a a frame (low remaining battery level frame) indicating that the remaining battery level has become low, and thus is notified that the remaining battery level of the communication terminal 1a has been low. The main control section 111a1 of the communication terminal 1a allows the transmission frame generating section 111c1 to generate the low remaining battery level frame, and allows the transmitting unit 150 to transmit the low remaining battery level frame to the management terminal 2.

Since the battery level detecting unit 120 notifies the main control section 111a1 of the communication terminal 1a that the remaining battery level has been low, the main control section 111a1 of the communication terminal 1a sets a minimum upper limit value which is smaller than the minimum limit value at the time of not notifying the fact that the remaining battery level has been low on the transmission wait time setting section 111c2. In addition, since the communication terminal 1a notifies the main control section 211a1 of the management terminal 2 that the remaining battery level of the communication terminal 1a has been low, the main control section 211a1 of the management terminal 2 sets a minimum upper limit value which is smaller than the minimum upper limit value at the time of not notifying the fact that the remaining battery level of the communication terminal 1a has been low on the transmission wait time setting section 219c2, when a frame with respect to the communication terminal 1a is transmitted.

In FIG. 8, a beacon frame 800 has already been transmitted from the management terminal 2, and the main control sections 111a1 of the communication terminals 1a and 1b turns on power from the time of receiving the beacon frame 800 of the time T80. In this embodiment, the management terminal 2 stores each one frame to be transmitted to the communication terminals 1a and 1b at the time T80. The beacon frame 800 has information for notifying storage of each frame.

The communication terminals 1a and 1b which have received the beacon frame 800 recognize that each frame is stored in the management terminal 2, and starts contention at time T81, which is time of terminating transmission of the beacon frame 800, in order to transmit a PS-Poll frame for requesting frame transmission. At this time, since the battery level detecting unit 120 notifies the main control section 111a1 of the communication terminal 1a that the remaining battery level has been low, the main control section 111a1 of the communication terminal 1a allows the transmission wait time setting section 111c2 to set a minimum upper limit value which is smaller than the minimum upper limit value at the time of not notifying the fact that the remaining battery level has been low.

The communication terminal 1a which has won the contention transmits the PS-Poll frame 801a. Sequentially, the management terminal 2 transmits an ACK frame 802, which is a response to the reception of the PS-Poll frame 801a.

The management terminal 2 and the communication terminal 1b start contention at time T82, which is time of terminating transmission of the ACK frame 802. The management terminal 2 which has won the contention transmits a data frame 803 to the communication terminal 1a. Sequentially, the communication terminal 1a transmits an ACK frame 802a, which is a response to the reception of the data frame 803, and turns off power after terminating the transmission of the ACK frame 802a.

The communication terminal 1b again starts the contention at time T83, which is time of terminating the transmission of the ACK frame 802a. However, since there is no contention opponent, the communication terminal 1b can transmit a PS-Poll frame 801b. Sequentially, the management terminal 2 transmits the ACK frame 802, which is a response to the reception of the PS-Poll frame 801b. The management terminal 2 again starts the contention at time point T84, which is time of terminating the transmission of the ACK frame 802. However, since there is no contention opponent, the management terminal 2 can transmit a data frame 803. Sequentially, the communication terminal 1b transmits the ACK frame 802b, which is a response to the reception of the data frame 803, and turns off power after terminating the transmission of the ACK frame 802b.

When the data frame 803 is voice data sampled at a 20 ms interval by a G.711 codec on the assumption that a frame transmission rate over the air is 11 Mbps, the minimum upper limit value at a normal time is 31 at the time of using an apparatus complying with a WiFi (Wireless Fidelity), and the minimum upper limit value at the low state of the remaining battery level is 15, an average time of the PS-Poll frame 801a to the ACK frame 802 is 578.8 μs, an average time of the PS-Poll frame 801b to the ACK frame 802 is 738.8 μs, an average time of the data frame 803 transmitted to the communication terminal 1a to the ACK frame 802a is 726.1 μs, and the data frame 803 transmitted to the communication terminal 1b to the ACK frame 802b is 886.1 μs.

That is, an average time from the time T81 to the time T83 is 578.8 μs+726.1 μs=1304.9 μs, and an average time from the time T83 to the time T85 is 738.8 μs+886.1 μs=1624.9 μs. Moreover, since the average time from the time T81 to the time T83 is an average time at the low state of the remaining battery level and the average time from the time T83 to the time T85 is an average time at the normal time, a relation of 1304.9/1624.9=0.803 is satisfied. Accordingly, even when only one communication terminal is present, the power of 19.7% can be reduced.

In the above description, the case where the communication terminal 1a has won the contention starting at the time T81 and the management terminal 2 has won the contention starting at the time T82 has been supposed. However, in practice, neither communication terminal 1a nor the management terminal 2 can necessarily win. A winning probability depends on the minimum upper limit value at the normal time and the minimum upper limit value at the low state of the remaining battery level.

For example, assuming that the minimum upper limit value at the normal time is 31 and the minimum upper limit value at the low state of the remaining battery level is 15, the total combinations are 32×16=512 cases. Winning combinations of a side having the minimum upper limit value 31 at the normal time are 120 cases, winning combinations of a side having the minimum upper limit value of 15 at the low state of the remaining battery level are 376 cases, and draw combinations are 16 cases. In addition, the probabilities thereof are 23.4%, 73.4%, and 3.1%, respectively.

Moreover, assuming that the minimum upper limit value at the normal time and the minimum upper limit value at the low state of the remaining battery level are all 31, the total combinations are 32×32=1024 cases. Winning combinations of a side at the normal time are 496 cases, winning combinations of a side at the low state of the remaining battery level are 496 cases, and drawing combinations are 32 cases. Moreover, the probabilities thereof are 48.4%, 48.4%, and 3.1%, respectively.

Accordingly, since the probability that the communication terminal 1a wins the contention starting at the time T81 in FIG. 8 over the communication terminal 1b becomes 73.4% from 48.4%, the communication terminal 1a easily wins the contention. Therefore, when the communication terminal 1b is transmitting the PS-Poll frame 810b, there decreases the probability that the communication terminal 1a turns on power. As a result, it is possible to improve a performance of reducing power consumption on the average.

Likewise, since the probability that the management terminal 2 wins the contention starting at the time T82 in FIG. 8 over the communication terminal 1b becomes 73.4% from 48.4%, the management terminal 2 easily wins the contention. Therefore, when the communication terminal 1b is transmitting the PS-Poll 810b, the probability that the power-on state continues decreases. As a result, it is possible to improve the performance of reducing power consumption on the average.

In this embodiment, two communication terminals have been used, but it is also true in a case where several communication terminals may be used.

In addition, in this embodiment, the minimum upper limit value is lowered than usual in both the communication terminal 1a and the management terminal 2. However, only the minimum upper limit value in one of the communication terminal 1a and the management terminal 2 may be lowered.

In this embodiment, there has been described the case where the minimum upper limit value at the normal time is 31 and the minimum upper limit value at the low state of the remaining battery level is 15. However, any value is possible as long as a value at the low state of the remaining battery level is smaller than the value at the normal time. In this embodiment, the power has been turned on immediately after the communication terminal 1a transmits the ACK frame 802a. However, the advantage of reducing the average power-on time is also obtained even when the power-on state continues for some time in consideration of a case where the management terminal 2 cannot receive the ACK frame 802a.

According the above-described embodiment, when the power saving communication terminal 1a which repeats the power-on and power-off operations detects that its remaining battery level has been low, a range of selecting the frame transmission wait time is more decreased, compared to a case of not detecting the fact that the remaining battery level is low. Moreover, when the communication terminal 1a notifies the management terminal 2 which is the communication opponent, that its remaining battery level has been low, a range of selecting the frame transmission wait time of the management terminal 2 is to be lowered, compared to a case of not notifying that the remaining battery level is low. Accordingly, the communication terminal 1a which is the power saving communication terminal having its low remaining battery level can transmit and receive a frame for the power-on time shorter than that at the normal time, when the communication terminal 1a transmits and receives the frame. As a result, it is possible to obtain an advantage of effectively reducing power consumption when the remaining battery level is low, that is, when power consumption has to be reduced more than that at the normal time.

### SECOND EMBODIMENT

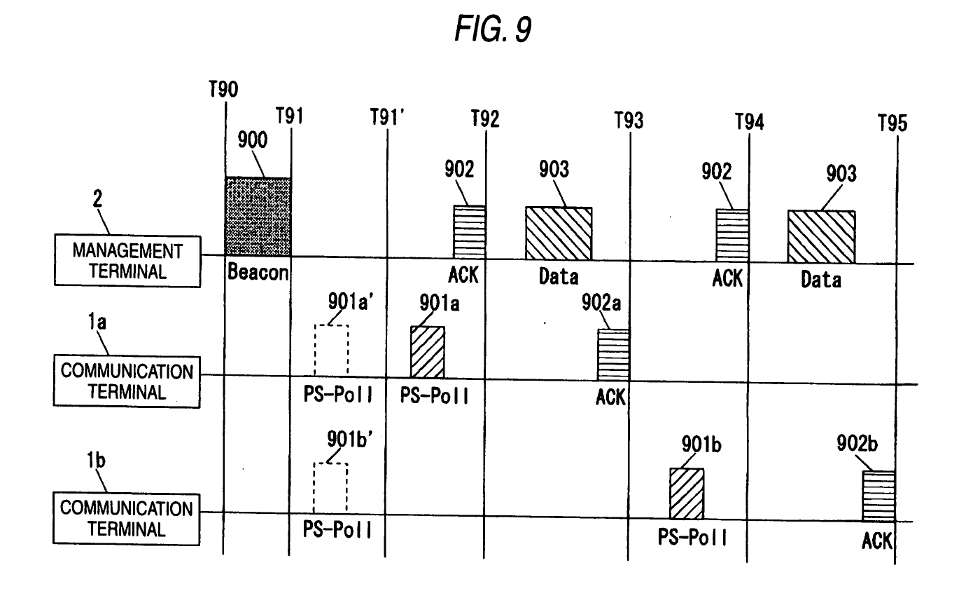

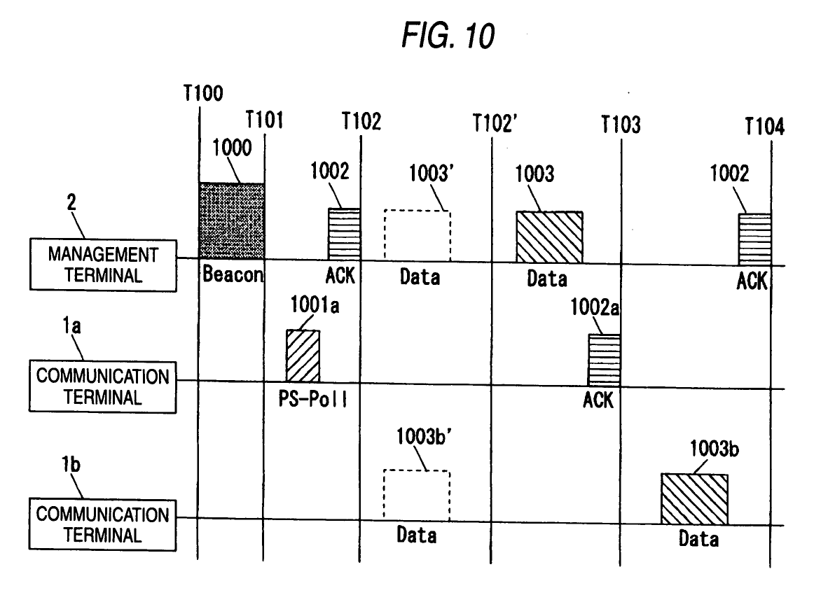

A second embodiment of the invention will be described with reference to FIGS. 6, 7, 9, and 10. FIGS. 9 and 10 are time charts in a communication system according to the second embodiment. Communication terminals 1a and 1b are each a power saving communication terminal which repeats power-on and power-off operations. A management terminal 2 and the communication terminal 1a are embodied according to the invention, but the communication terminal 1b is not embodied according to the invention.

That is, at a normal time, a main control section 111a1 of the communication terminal 1a sets a minimum upper limit value and a maximum upper limit value of a random number generation range on a transmission wait time setting section 111c2. At the time of transmitting a frame, the transmission wait time setting section 111c2 sequentially increases a range of selecting wait time before frame transmission from the minimum upper limit value, whenever the frame is retransmitted. However, when it is notified from the battery level detecting unit 120 that the remaining battery level has been low, the main control section 111a1 of the communication terminal 1a sets the maximum upper limit value to the same value as the minimum upper limit value at the time of transmitting the frame on the transmission wait time setting section 111c2, and does not change the range of selecting wait time from the minimum upper limit value.

On the other hand, at the time of transmitting a frame, a transmission wait time setting section 111c2 of the communication terminal 1b sequentially increases a range of selecting wait time before frame transmission from the minimum upper limit value, whenever the frame is retransmitted.

When the communication terminal 1a notifies a main control section 211a of the management terminal 2 that the remaining battery level has been low, the main control section 211a of the management terminal 2 sets the maximum upper limit value to the same value as the minimum upper limit value on a transmission wait time setting section 219a2, and does not change the range of selecting the wait time from the minimum upper limit value at the time of transmitting the frame to the communication terminal 1a.

Until time T90 and time T100, the battery level detecting unit 120 notifies the main control section 111a1 of the communication terminal 1a that the remaining battery level has been low. In addition, the main control section 211a of the management terminal 2 receives from the communication terminal 1a a frame (low remaining battery level frame) indicating that the remaining battery level has been low, and is notified that the remaining battery level of the communication terminal 1a has been low. The main control section 111a1 of the communication terminal 1a allows a transmission frame generating section 111c1 to generate the low remaining battery level frame and allows a transmitting unit 150 to transmit the low remaining battery level frame to the management terminal 2. Hereinafter, operations of a communication system according to this embodiment will be described.

First, the operations will be described with reference to FIG. 9. During a period of time shown in FIG. 9, the communication terminals 1a and 1b each receive one frame stored in the management terminal 2. In FIG. 9, a beacon frame 900 has already been transmitted from the management terminal 2, and the main control section 111a1 of the respective communication terminals 1a and 1b turns on power from the time of receiving the beacon frame 900 at the time T90. In this embodiment, the management terminal 2 stores one frame to be transmitted to each of the communication terminals 1a and 1b at the time T90. The beacon frame 900 has information for notifying storage of each frame.

The communication terminals 1a and 1b which have received the beacon frame 900 recognize that each frame is stored in the management terminal 2, and starts contention at time T91, which is time of terminating transmission of the beacon frame 900, in order to transmit a PS-Poll frame for requesting frame transmission. At this time, since basic unit time for transmission wait selected from 0 to the minimum upper limit value by the communication terminal 1a is equal to that selected by the communication terminal 1b, a PS-Poll frame 901a′ and a PS-Poll frame 901b′ collide with each other. Thus, neither the PS-Poll frame 901a′ nor the PS-Poll frame 901b′ is normally received in the management terminal 2. For that reason, an ACK frame 902 cannot be transmitted from the management terminal 2.

Since the communication terminals 1a and 1b cannot receive the ACK frame 902 within a predetermined period of time, retransmission is determined at the T91′ and the contention is resumed. At this time, in the communication terminal 1a, the battery level detecting unit 120 notifies the main control section 111a1 that the remaining battery level has been low. Accordingly, the main control section 111a1 allows the transmission wait time setting section 111c2 to set the maximum upper limit value to the same value as the minimum upper limit value at the time of transmitting the frame, and does not change the range of selecting the wait time from a minimum selection range. On the other hand, at the time of transmitting a frame, the transmission wait time setting section 111c2 of the communication terminal 1b sequentially increases a range of selecting the wait time before frame transmission from the minimum selection range.

The communication terminal 1a which has won the contention for acquiring a frame transmission right transmits a PS-Poll frame 901a. Sequentially, the management terminal 2 transmits an ACK frame 902 which is a response to the reception of the PS-Poll frame 901a.

The management terminal 2 and the communication terminal 1a start contention at time T92 which is time of terminating the transmission of the ACK frame 902. Sequentially, the management terminal 2 which has won the contention transmits a data frame 903 to the communication terminal 1a. Sequentially, the communication terminal 1a transmits an ACK frame 902a which is a response to the reception of the data frame 903 and turns off power after the transmission of the ACK frame 902a is terminated.

The communication terminal 1b resumes the contention at time T93 which is time of terminating the transmission of the ACK frame 902a. However, since there is no contention opponent, the communication terminal 1b can transmit a PS-Poll frame 901b. Sequentially, the management terminal 2 transmits the ACK frame 902 which is a response to the reception of the PS-Poll frame 901b. The management terminal 2 resumes the contention at time T94 which is time of terminating the transmission of the ACK frame 902. However, since there is no contention opponent, the management terminal 2 can transmit a data frame 903. Sequentially, the communication terminal 1b transmits an ACK frame 902b which is a response to the reception of the data frame 903 to turn off power after the transmission of the ACK frame 902b is terminated.

In the above description, the case where the communication terminal 1a has won the contention starting at the time T91′ has been supposed. However, in practice, the communication terminal 1a cannot necessarily win. A winning probability depends on the upper limit value of an initial retransmission at the normal time and the upper limit value of an initial retransmission at the time at which the remaining battery level is not low.

For example, assuming that the upper limit value of the initial retransmission at the normal time is 63 in a case of using an apparatus complying with the WiFi and the upper limit value of the initial retransmission at the low state of the remaining battery level is 31, the total combinations are 64×32=2048 cases. Winning combinations of a side having the upper limit value of 63 are 496 cases, winning combinations of a side having the upper limit value of 31 are 1520 cases, and draw combinations are 32 cases. In addition, the probabilities thereof are 24.2%, 74.2%, and 1.6%, respectively.

Moreover, assuming that the upper limit value of the initial retransmission at the normal time and the upper limit value of the initial retransmission at the low state of the remaining battery level are all 63, the total combinations are 64×64=4096 cases. Winning combinations of a side at the normal time are 2016 cases, winning combinations of a side at the low state of the remaining battery level are 2016 cases, and draw combinations are 64 cases. Moreover, the probabilities thereof are 49.2%, 49.2%, and 1.6%, respectively.

Accordingly, since the probability that the communication terminal 1a wins the contention starting at the time T91′ in FIG. 9 over the communication terminal 1b becomes 74.2% from 49.2%, the communication terminal 1a easily wins the contention. Therefore, when the communication terminal 1b is transmitting the PS-Poll frame 910b, there decreases the probability that the communication terminal 1a turns on power. As a result, it is possible to improve a performance of reducing power consumption of the communication terminal 1a on the average.

Next, the operation will be described with reference to FIG. 10. During a period of time shown in FIG. 10, the communication terminal 1a which is embodied according to the invention receives one frame from the management terminal 2, and the communication terminal 1b which is not embodied according to the invention transmits one frame to the management terminal 2. In FIG. 10, a beacon frame 1000 has already been transmitted from the management terminal 2, and the communication terminals 1a and 1b turn on power from a time of receiving the beacon frame 1000 at the time T100. In this embodiment, the management terminal 2 stores a frame to be transmitted to the communication terminal 1a at the time T100. The beacon frame 1000 has information for notifying storage of the frame.

The communication terminal 1a recognizes that the frame is stored in the management terminal 2 and starts contention at time T101, which is time of terminating transmission of the beacon frame 1000, in order to transmit a PS-Poll frame for requesting frame transmission. Moreover, the communication terminal 1b recognizes that a frame is not stored in the management terminal 2 and starts the contention at the time T101 in order to transmit a frame to the prepared management terminal 2. Then, the communication terminal 1a which has won the contention transmits a PS-Poll frame 1001a. Sequentially, the management terminal 2 transmits an ACK frame 1002 which is a response to the reception of the PS-Poll frame 1001a.

The management terminal 2 and the communication terminal 1b start contention at time T102 which is time of terminating the transmission of ACK frame 1002. However, since basic unit time for transmission wait selected from 0 to the minimum upper limit value by the management terminal 2 is equal to basic unit time for transmission wait remaining in the communication terminal 1b at the time T102, a data frame 1003′ and a data frame 1003b′ collide with each other. Thus, the data frame 1003′ and the data frame 1003b′ is not normally received in the management terminal 2 and the communication terminal 1a, respectively. For that reason, an ACK frame 1002 is not transmitted from the management terminal 2, and an ACK frame 1002a is not transmitted from the communication terminal 1a.

Since the management terminal 2 and the communication terminal 1b cannot receive the ACK frame 1002 and the ACK frame 1002a within a predetermined period of time, respectively, retransmission is determined at the T102′ and the contention is started. At this time, the fact that the remaining battery level has been low is notified to the management terminal 2 from the communication terminal 1a. Accordingly, the main control section 211a allows the transmission wait time setting section 219a2 to set the maximum upper limit value to the same value as the minimum upper limit value at the time of transmitting the frame to the communication terminal 1a, and does not change the range of selecting the wait time from a minimum selection range. On the other hand, at the time of transmitting the frame, the transmission wait time setting section 111c2 of the communication terminal 1b sequentially increases a range of selecting the wait time before frame transmission from the minimum upper limit value.

The management terminal 2 which has won the contention for acquiring a frame retransmission right transmits a data frame 1003. Sequentially, the communication terminal 1a transmits an ACK frame 1002a which is a response to the reception of the data frame 1003, and turns off power after it terminates the transmission of the ACK frame 1002a.

The communication terminal 1b resumes the contention at time T103 which is time of terminating the transmission of the ACK frame 1002a. However, since there is no contention opponent, the communication terminal 1b can transmit the data frame 1003b. Sequentially, the management terminal 2 transmits an ACK frame 1002 which is a response to the reception of the data frame 1003b, and the communication terminal 1b turns off power after it terminates the transmission of the ACK frame 1002.

In the above description, the case where the management terminal 2 has won the contention starting at the time T102′ has been supposed. However, in practice, the management terminal 2 cannot necessarily win. A winning probability depends on the upper limit value of an initial retransmission at the normal time and the upper limit value of an initial retransmission at the time at which the remaining battery level is not low.

For example, assuming that the upper limit value of the initial retransmission at the normal time is 63 in a case of using an apparatus complying with the WiFi and the upper limit value of the initial retransmission at the low state of the remaining battery level is 31, the total combinations are 64×32=2048 cases. Winning combinations of a side having the upper limit value of 63 are 496 cases, winning combinations of a side having the upper limit value of 31 are 1520 cases, and drawing combinations are 32 cases. In addition, the probabilities thereof are 24.2%, 74.2%, and 1.6%, respectively.

Accordingly, since the probability that the management terminal 2 wins the contention starting at the time T102′ in FIG. 10 over the communication terminal 1b becomes 74.2% from 49.2%, the management terminal 2 easily wins the contention. Therefore, when the communication terminal 1b is transmitting the data frame 1003b, there decreases the probability that the communication terminal 1a turns on power. As a result, it is possible to improve a performance of reducing power consumption of the communication terminal 1a on the average.

In this embodiment, two communication terminals have been used, but it is also true in a case where several communication terminals may be used. In addition, in this embodiment, the minimum upper limit value is not changed at the time of retransmitting the frame in both the communication terminal 1a and the management terminal 2. However, only the minimum upper limit value in one of the communication terminal 1a and the management terminal 2 may not be changed.

In this embodiment, there has been described the case where the upper limit value at the normal time is 63 at the time of the initial retransmission and the upper limit value at the low state of the remaining battery level is fixed as 31. However, any value is possible as long as the fixed upper limit value at the low state of the remaining battery level is smaller than the upper limit value at the time of the retransmission. In this embodiment, the power has been turned on immediately after the communication terminal 1a transmits the ACK frame 902a and the ACK frame 1002a. However, the advantage of reducing the average power-on time is also obtained even when the power-on state continues for some time in consideration of a case where the management terminal 2 cannot receive the ACK frame 902a and the ACK frame 1002a.

According the above-described embodiment, in a case where the communication terminal 1a does not detect that the remaining battery level has been low when the power saving communication terminal 1a for repeating the power-on and power-off operations transmits the frame to the management terminal 2, the range of selecting the wait time before the frame transmission is sequentially increased from the minimum upper limit value whenever the frame is retransmitted. Moreover, in a case where the communication terminal 1a detects that the remaining battery level has been low, the range of selecting the wait time is not changed from the minimum upper limit value. Accordingly, the communication terminal 1a which is the power saving communication terminal having the low remaining battery level can retransmit the frame for time shorter than that at the normal time, when the communication terminal 1a transmits the frame. As a result, it is possible to obtain an advantage of effectively reducing power consumption when the remaining battery level is low, that is, when power consumption has to be reduced more than that at the normal time.

According the above-described embodiment, in a case where the communication terminal 1a does not notify the management terminal 2 that the remaining battery level has been low when the management terminal 2 transmits the frame to the communication terminal 1a which is the power saving communication terminal for repeating the power-on and power-off operations transmits the frame, the range of selecting the wait time before the frame transmission is sequentially increased from the minimum upper limit value whenever the frame is retransmitted. Moreover, when the communication terminal 1a notifies the management terminal 2 that the remaining battery level has been low, the range of selecting the wait time is not changed from the minimum upper limit value. Accordingly, the management terminal 2 which retransmits the frame to the communication terminal 1a can retransmit the frame for the time shorter than that at the normal time, when the communication terminal 1a having the low remaining battery level receives the frame. Therefore, since it is easy to win the contention for acquiring the frame retransmission right over the communication terminal 1b, it is possible to decrease a probability that the communication terminal 1a turns on power to receive a frame during the frame transmission of the communication terminal 1b. As a result, it is possible to obtain the advantage of effectively reducing power consumption when the remaining battery level of the communication terminal 1a is low, that is, when power consumption has to be reduced more than that at the normal time.

### THIRD EMBODIMENT

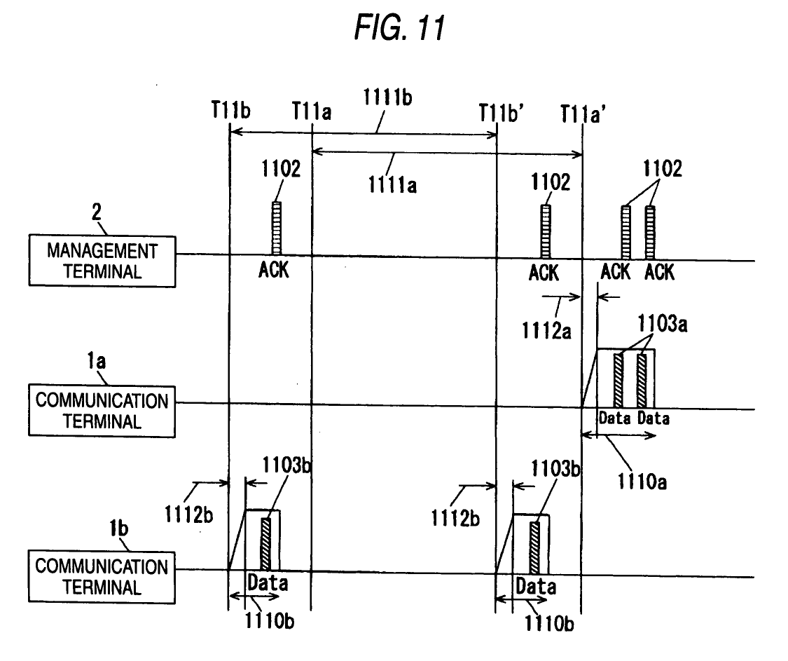

A third embodiment of the invention will be described with reference to FIGS. 6, 7, and 11. FIG. 11 is a time chart in a communication system according to the third embodiment. Communication terminals 1a and 1b are each a power saving communication terminal which repeats power-on and power-off operations. The communication terminal 1a is embodied according to the invention, but the communication terminal 1b is not embodied according to the invention. That is, a main control section 111a1 allows a power-on/ff section 111a2 to set power-on under the condition that plural frames are stored in a transmission frame content storing unit 112, and the communication terminal 1a transmits the plural frames at one time, when a battery level detecting unit 120 notifies the main control section 111a1 that the remaining battery level has been low. On the other hand, the communication terminal 1b performs a normal frame transmission.

Until time T11a, the battery level detecting unit 120 notifies the main control section 111a1 of the communication terminal 1a that the remaining battery level has been low.

Hereinafter, operations of the communication system according to this embodiment will be described. During a period of time shown in FIG. 11, the communication terminals 1a and 1b each transmit two frames to the management terminal 2 at cycles 111a and 111b equal to each other, respectively. The communication terminal 1b prepares a frame to be transmitted to the management terminal 2 at time 111b and time T11b′, and turns on power at the time T11b and the time T11b′ to transmit each one frame. In addition, the communication terminal 1b turns off power whenever it terminates the transmission of the frame.

The communication terminal 1a prepares each one frame to be transmitted to the management terminal 2 at time T11a and time T11a′ (not shown). However, since only one frame to be transmitted to the management terminal 2 is prepared at the time T11a, the communication terminal 1a does not turn on power at the time T11a and turns on power at the time T11a′ of preparing two frames to be transmitted to the management terminal 2 to transmit the frames. In addition, the communication terminal 1a turns off power after it terminates the transmission of the frames.

At this time, it is necessary to consider a specific difference between the power-on time of the communication terminal 1a and the power-on time of communication terminal 1b shown in FIG. 11. Power-on time 1110a of the communication terminal 1a is not fixed, but is constructed as “setup time 1112a+(average time of the data frame 1103a to the ACK frame 1102)×2” on the average. Power-on time 1110b of the communication terminal 1b is constructed as “setup time 1112b+ average time of the data frame 1103b to the ACK frame 1102”.

The setup times 1112a and 1112b refer to time during which a circuit in the power-off state can be operated, and includes time during which the power source of the circuit is turned on and setting an operation is performed. Generally, time from several milliseconds to several tens milliseconds is necessary. In addition, the “average time of the data frame 1103a to the ACK frame 1102” and the “average time of the data frame 1103b to the ACK frame 1102” become the same value if a minimum upper limit value, a transmission byte, and a transmission rate of the data times 1103a and 1103b are equal to each other. In FIG. 11, the minimum upper limit value, the transmission byte, and the transmission rate are supposed to be equal to each other.

In this case, the total power-on time of the communication terminal 1a in FIG. 11 is “setup time 1112a+(average time of the data frame 1103a to the ACK frame 1102)×2” of only the power-on time 1110a. In addition, the total power-on time of the communication terminal 1b is “(setup time 1112b+ average time of the data frame 1103b to the ACK frame 1102)×2)” of “two times of the power-on time 1110b”. Accordingly, the power-on time of the communication terminal 1a is shorter than that of the communication terminal 1b by one power-on time.

When the data frame 1103a is voice data sampled at a 20 ms interval by a G.711 codec on the assumption that a frame transmission rate over the air is 11 Mbps and the minimum upper limit value is 31, an average time of the data frame 1103a to the ACK frame 1102 is 886.1 μs. The setup times 1112a and 1112b are assumed to be 2 ms.

The total power-on time of the communication terminal 1a becomes “the setup time 1112a+(the average time of the data frame 1103a to the ACK frame 1102)×2”=“(2000+886.1×2)=3772.2 μs. In addition, the total power-on time of the communication terminal 1b becomes “(the setup time 1112b+ the average time of the data frame 1103a to the ACK frame 1102)×2”=((2000+886.1)×2)=5772.2 μs. Accordingly, since the relation of 3772.2/5772.2=0.654 is satisfied, the power consumption of 34.6% can be reduced during the period of time shown in FIG. 11.

In this embodiment, two communication terminals have been used, but it is also true in a case where several communication terminals may be used. In this embodiment, the communication terminal 1a transmits two prepared frames, but the invention is not limited to the two frames. It is also true that two or more frames can be transmitted if the two or more frames are prepared.

In the above-described embodiment, the communication terminal 1a, which is a power saving communication terminal for repeating power-on and power-off operations, transmits a frame to the management terminal 2. At this time, the communication terminal 1a turns on power at the timing of preparing the plural frames to transmit the plural frames, when it detects that its remaining battery level has been low. That is, the communication terminal 1a having the low remaining battery level transmits the plural frames at one time when it transmits the frames. Accordingly, the communication terminal 1a having the low remaining battery level can reduce the setup time necessary to turn on power to transmit the frames. As a result, since the power-on time can be reduced, it is possible to obtain an advantage of effectively reducing power consumption when the remaining battery level is low, that is, when power consumption has to be reduced more than that at the normal time.

### FOURTH EMBODIMENT

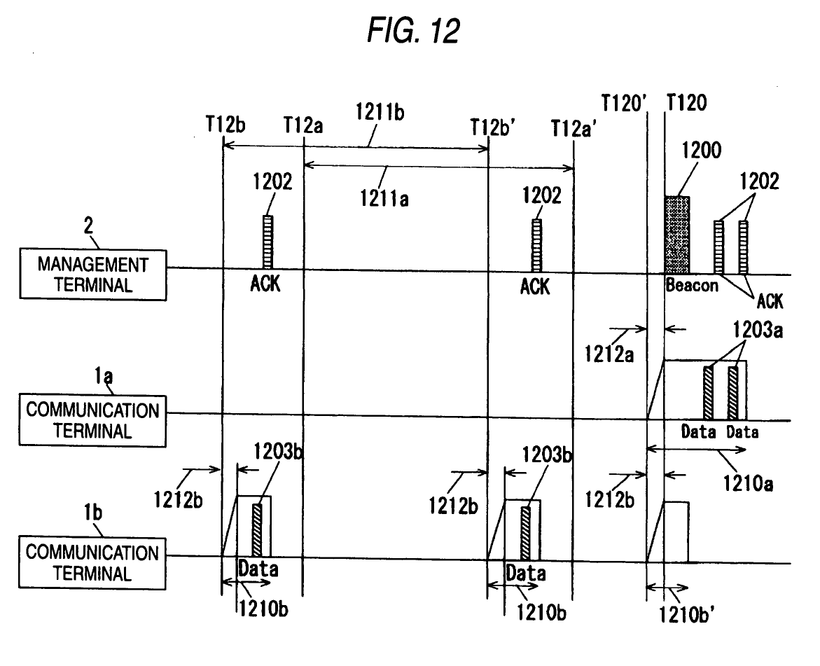

A fourth embodiment of the invention will be described with reference to FIGS. 6, 7, and 12. FIG. 12 is a time chart in a communication system according to the fourth embodiment. Communication terminals 1a and 1b are each a power saving communication terminal which repeats power-on and power-off operations. The communication terminal 1a is embodied according to the invention, but the communication terminal 1b is not embodied according to the invention. That is, in the communication terminal 1a, the battery level detecting unit 120 informs the main control section 111a1 that the remaining battery level has been low. At this time, the main control section 111a1 of the communication terminal 1a does not transmit a frame at timing of storing the frame in the transmission frame content storing unit 112. In addition, the main control section 111a1 allows a power-on/off section 111a2 to set power-on at timing of a reference frame of the management terminal 2 and turns on the power of a transmitting unit 150. In addition, a frame content reading section 111c4 notifies the reception of the reference frame. At this time, the frame is transmitted when the frame is stored in the transmission frame content storing unit 112. On the other hand, the communication terminal 1b performs a normal frame transmission.

Until time T12a, the battery level detecting unit 120 notifies the main control section 111a1 of the communication terminal 1a that the remaining battery level has been low.

Hereinafter, operations of the communication system according to this embodiment will be described. During a period of time shown in FIG. 12, the communication terminals 1a and 1b each transmit two frames to the management terminal 2 at cycles 1211a and 1211b equal to each other, respectively. The communication terminal 1b prepares a frame to be transmitted to the management terminal 2 at time T12b and time T12b′, and turns on power at the time T12b and the time T12b′ to transmit one frame. In addition, the communication terminal 1b turns on power at time T120′, which is prior to time T120 by time 1212a or time 1212b, in order to receive a beacon frame 1200 at time T120.

The communication terminal 1a prepares a frame to be transmitted to the management terminal 2 at time T12a and time T12a′ (not shown). However, the communication terminal 1a does not turn on power at the time T12a and the time T12a′, and transmits two frames to be transmitted to the management terminal 2 at one time after it receives the beacon frame 1200 at the time T120.

At this time, it is necessary to consider a specific difference between the power-on time of the communication terminal 1a and the power-on time of communication terminal 1b shown in FIG. 12. Power-on time 1210a of the communication terminal 1a is constructed as “setup time 1212a+ reception time of the beacon frame 1200+(average time of the data frame 1203a to the ACK frame 1202)×2”. Power-on time 1210b of the communication terminal 1b is constructed as “setup time 1212b+ average time of the data frame 1203b to the ACK frame 1202”. Power-on time 1210b′ of the communication terminal 1b is constructed as “setup time 1212b+ reception time of the beacon frame 1200”.

The setup times refer to time during which a circuit in the state of power-off can be operated, and includes time during which the power source of the circuit is turned on and setting operations is performed. Generally, time from several milliseconds to several tens milliseconds is necessary. In addition, the “average time of the data frame 1203a to the ACK frame 1202” and the “average time of the data frame 1203b to the ACK frame 1202” become the same value if a minimum upper limit value, a transmission byte, and a transmission rate of the data times 1203a and 1203b are equal to each other. In FIG. 12, the minimum upper limit value, the transmission byte, and the transmission rate are supposed to be equal to each other.

In this case, the total power-on time of the communication terminal 1a in FIG. 12 is “setup time 1212a+ reception time of the beacon frame 1200+(average time of the data frame 1203a to the ACK frame 1202)×2” of only the power-on time 1210a. In addition, the total power-on time of the communication terminal 1b is “setup time 1212b×3+ reception time of the beacon frame 1200+(average time of the data frame 1203b to the ACK frame 1202)×2)” of “the power-on time 1210b×2+ the power-on time 1210b′”. Accordingly, the power-on time of the communication terminal 1a is shorter than that of the communication terminal 1b by two power-on time.

When the data frame 1203a is voice data sampled at a 20 ms interval by a G.711 codec on the assumption that a frame transmission rate over the air is 11 Mbps and the minimum upper limit value is 31, an average time of the data frame 1203a plus the ACK frame 1202 is 886.1 μs. In addition, on the assumption that the transmission rate of the beacon frame 1200 is 1 Mbps, time of about 1 ms is necessary to transmit the beacon frame 1200, and the setup times 1212a and 1212b are assumed to be 2 ms.

The total power-on time of the communication terminal 1a becomes “the setup time 1212a++reception time of the beacon frame 1200+(the average time of the data frame 1203a to the ACK frame 1202)×2”=“(2000+1000+886.1×2)=4772.2 μs. In addition, the total power-on time of the communication terminal 1b becomes “(the setup time 1212b×3+ reception time of the beacon frame 1200+(average time of the data frame 1203a to the ACK frame 1202)×2”=(2000×3+1000+886.1×2)=8772.2 μs. Accordingly, since the relation of 4772.2/8772.2=0.544 is satisfied, the power consumption of 45.6% can be reduced during the period of time in FIG. 12.

In this embodiment, two communication terminals have been used, but it is also true in a case where several communication terminals may be used.

In the above-described embodiment, when the communication terminal 1a, which is managed by the management terminal 2 and is a power saving communication terminal for repeating power-on and power-off operations, detects that its remaining battery level has been low, the communication terminal 1a does not transmit the frame at the timing of preparing the frame, but transmits the frame when it turns on power in order to receive the reference frame of the management terminal 2. Accordingly, the setup time necessary to turn on power to transmit only the frame from the communication terminal 1a is not required. As a result, since the power-on time of the communication terminal 1a can be reduced, it is possible to obtain an advantage of effectively reducing the power consumption when the remaining battery level is low, that is, when power consumption has to be reduced more than that at the normal time.

According to the invention, communication terminals are effectively used in a communication system where the communication terminals such as a wireless telephone terminal or a PDA using a battery as a driving source are used and thus it is difficult to charge the communication terminals even when its remaining battery level has been low.

This application is based upon and claims the benefit of priority of Japanese Patent Application No. 2007-152315 filed on Jun. 8, 2007, the contents of which are incorporated herein by reference in its entirety.

What is claimed is:

1. A communication apparatus, comprising:
a battery;
a battery level detecting unit which detects a remaining battery level of the battery;
a transmitting unit which transmits data;
a wait time setting unit which determines an upper limit value from a minimum upper limit value to a maximum upper limit value for a random number generation range when the transmitting unit transmits the data, generates a random number up to the upper limit value, and sets a wait time for transmitting the data on the basis of the random number; and
a control unit which sets the minimum upper limit value and the maximum upper limit value for the random number generation range on the wait time setting unit,
wherein the control unit sets at least one of the minimum upper limit value and the maximum upper limit value in a different manner from a normal control time in case that the control unit receives data indicating that the remaining battery level is detected to be low from the battery level detecting unit.

2. The communication apparatus according to claim 1, wherein the wait time setting unit sets the minimum upper limit value as the upper limit value when the data is initially transmitted; and
wherein the control unit sets a value smaller than the minimum upper limit at the normal control time as the minimum upper limit on the wait time setting unit in case that the control unit receives the data indicating that the remaining battery level is detected to be low from the battery level detecting unit.

3. The communication apparatus according to claim 1, wherein the wait time setting unit sets the minimum upper limit value as the upper limit value when the data is initially transmitted; and
wherein the control unit sets the maximum upper limit value as the same value as the minimum upper limit value on the wait time setting unit in case that the control unit receives the data indicating that the remaining battery level is detected to be low from the battery level detecting unit.

4. A communication apparatus, comprising:
a receiving unit which receives data;
a transmitting unit which transmits data;
a wait time setting unit which determines an upper limit value from a minimum upper limit value to a maximum upper limit value for a random number generation range when the transmitting unit transmits the data, generates a random number up to the upper limit value, and sets a wait time for transmitting the data on the basis of the random number; and
a control unit which sets the minimum upper limit value and the maximum upper limit value for the random number generation range on the wait time setting unit,
wherein the control unit sets at least one of the minimum upper limit value and the maximum upper limit value in a different manner from a normal control time in case that the receiving unit receives data indicating that a remaining battery level of another communication apparatus is low.

5. The communication apparatus according to claim 4, wherein the wait time setting unit sets the minimum upper limit value as the upper limit value when the data is initially transmitted; and
wherein the control unit sets a value smaller than the minimum upper limit value at the normal control time as the minimum upper limit value in case that the receiving unit receives the data indicating that the remaining battery level of the another communication apparatus is low.

6. The communication apparatus according to claim 4, wherein the wait time setting unit sets the minimum upper limit value as the upper limit value when the data is initially transmitted; and
wherein the control unit sets the maximum upper limit value as the same value as the minimum upper limit value on the wait time setting unit in case that the receiving unit receives the data indicating that the remaining battery level of the another communication apparatus is low.

7. A communication method of a communication apparatus for communicating with another communication apparatus, the method comprising:
detecting a remaining battery level of a battery in the communication apparatus;
transmitting data;
determining a minimum upper limit and a maximum upper limit for a random number generation range in the data transmitting process;
generating a random number up to the upper limit;
determining a wait time for the data transmitting on the basis of the random number; and
setting at least one of the minimum upper limit and the maximum upper limit in a different manner from a normal time in case that the remaining battery is detected to be low.

8. The communication method according to claim 7, wherein the minimum upper limit value is set as the upper limit value when the data is initially transmitted; and
wherein a value smaller than the minimum upper limit at the normal control time is set as the minimum upper limit in case that the remaining battery level is detected to be low.

9. The communication method according to claim 7, wherein the minimum upper limit value is set as the upper limit value when the data is initially transmitted; and
wherein the maximum upper limit value is set as the same value as the minimum upper limit value in case that the remaining battery level is detected to be low.

10. A communication method of a communication apparatus for communicating with another communication apparatus, the method comprising:
receiving data
transmitting data;
determining a minimum upper limit and a maximum upper limit for a random number generation range in the data transmitting process;
generating a random number up to the upper limit;
determining a wait time for the data transmitting on the basis of the random number; and
setting at least one of the minimum upper limit and the maximum upper limit in a different manner from a normal time when receiving data indicating that the remaining battery of the another communication apparatus is low.

11. The communication apparatus according to claim 10, wherein the minimum upper limit value is set as the upper limit value when the data is initially transmitted; and
wherein a value smaller than the minimum upper limit value at the normal time is set as the minimum upper limit value when receiving the data indicating that the remaining battery level of the another communication apparatus is low.

12. The communication apparatus according to claim 10, wherein the minimum upper limit value is set as the upper limit value when the data is initially transmitted; and
wherein the maximum upper limit value is set as the same value as the minimum upper limit value when receiving the data indicating that the remaining battery level of the another communication apparatus is low.
